(19) United States
(12) Patent Application Publication
(10) Pub. No.: US 2021/0310917 A1
(43) Pub. Date: Oct. 7, 2021

(54) INVERSION IDENTIFICATION METHOD OF CRYSTAL PLASTICITY MATERIAL PARAMETERS BASED ON NANOINDENTATION EXPERIMENTS

(71) Applicant: DALIAN UNIVERSITY OF TECHNOLOGY

(72) Inventors: Wei JIANG, Dalian, Liaoning (CN); Yinyin LI, Dalian, Liaoning (CN)

(21) Appl. No.: 17/281,032

(22) PCT Filed: Nov. 10, 2020
(86) PCT No.: PCT/CN2020/127686

§ 371 Date: Mar. 29, 2021

(30) Foreign Application Priority Data
Dec. 12, 2019 (CN) 201911271059.3

(51) Int. Cl. G01N 3/08; G01N 1/32

(52) U.S. Cl. CPC G01N 3/08; G01N 1/32

(57) ABSTRACT

The present disclosure provides a method for inversion of crystal plasticity material parameters based on nanoindentation experiments. The method comprises: firstly, obtaining the elastic modulus of material by Oliver-Pharr method; secondly, establishing a macroscopic parameter inversion model of nanoindentation, correcting actual nanoindentation experimental data by pile-up/sink-in parameters and calculating macroscopic constitutive parameters of indentation material in combination with a Kriging surrogate model and a genetic algorithm; and finally, establishing a polycrystalline finite element model for a tensile specimen based on crystal plasticity finite element method, and calculating the crystal plasticity material parameters according to the calculated constitutive parameters of the material in combination with the Kriging surrogate model and the genetic algorithm. Compared with the prior art, the present disclosure can improve the calculation accuracy, reduce the amount of calculation and enhance calculation convergence, and has both practical and guideline values for the inversion of crystal plasticity material parameters.

### TECHNICAL FIELD

The present disclosure belongs to the technical field of characterization of mechanical properties of materials, and relates to a microscopic constitutive parameter calibration method for crystal plasticity material parameters based on the inversion of nanoindentation experiments.

### BACKGROUND

The meso-mechanical behavior of materials directly affects the strength and other macro-mechanical properties of the materials. The study of the mechanical behavior of materials from the meso-scale is conducive to deepening the understanding for the mechanisms of material deformation and damage, and is of great significance to the use of materials and the improvement of properties. In the study of mesomechanics, the strengthening of crystal materials is an important part of the elastoplastic constitutive description of crystal materials. Peirce et al. proposed a simple form of crystal slip hardening moduli in the journal “Acta Metallurgica” in issue 6 of 1982:

$${h}_{α α} = h ( γ ) = {h}_{0} s e c {h}^{2} \vert \frac{{h}_{0} γ}{{τ}_{s} - {τ}_{0}} \vert \\ {h}_{α β} = qh ( γ ) ( α \neq β )$$

wherein h_{αβ} represents the slip hardening moduli which comprise a self hardening modulus h_{αα} and a latent hardening modulus h_{αβ}(α≠β); γ is Taylor cumulative shear strain on all slip systems; h₀ is the initial hardening modulus; τₛ is stage I stress; τ₀ is the initial yield stress; and q is a constant. The accurate identification of the crystal plasticity constitutive parameters is the basis for studying the crystal plasticity mechanical behavior of materials.

With the appearance of high-resolution testing equipment, an indentation test has become one of the most frequently-used technologies to characterize mechanical properties of various materials, especially materials with small volumes or sizes. The crystal plasticity constitutive parameters can be accurately identified by using nanoindentation technology. The testing method requires accurate understanding of the relationship between the contact force and the contact depth on an indentation specimen. In the process of indentation test, the flow of the indented materials may be different due to the difference in mechanical properties. The material around an indentation contact area can deform upward (pile-up) or downward (sink-in) along the application direction of loads. The surface deformation mode will affect the true contact area between an indenter and the specimen, which will affect the measurement accuracy. In the existing methods for identifying crystal plasticity constitutive parameters based on nanoindentation, a crystal plasticity finite element model of nanoindentation needs to be established, which has a large amount of calculation and poor convergence; moreover, the relationship between pile-up/sink-in deformation of an indentation model under calibration parameters and pile-up/sink-in deformation in the actual test is not considered in calculation. Since the uniqueness of the solution to an inversion problem is difficult to be ensured, it is easier to obtain an accurate solution if fewer parameters need to be inverted. The technology of solving elastic parameters (elastic moduli) by nanoindentation is mature. Therefore, if the elastic parameters are first solved and then the plasticity parameters of the materials are inverted, not only the amount of calculation can be reduced, but also an accurate solution can be obtained more easily. However, if no accurate load-displacement (penetration depth) curve is provided, a large error may be caused in the calculation results, which makes it difficult to identify the constitutive parameters of the materials quickly and accurately.

### SUMMARY

In order to overcome the above defects of the prior art, the purpose of the present disclosure is to provide a microscopic constitutive parameter calibration method for crystal plasticity material parameters based on the inversion of nanoindentation experiments. Indentation responses of load-displacement (penetration depth) curves and contact stiffness are obtained through nanoindentation tests of metal materials. The conventional finite element model of nanoindentation is established through ABAQUS software, and the nanoindentation process on the metal materials is simulated by using a piecewise linear/power-law hardening material model. A parameter inversion model is established in combination with MATLAB and ABAQUS; Latin hypercube sampling is used to extract the constitutive parameters of the piecewise linear/power-law hardening material model as input variables; the load-displacement curves and an indentation pile-up/sink-in parameter of the conventional finite element indentation are used as output variables; the errors between the simulated data and the experimental data are calculated; a Kriging surrogate model of the constitutive parameters and the errors is established by using MATLAB; then single-target optimization is conducted by using a genetic algorithm with the target of the minimum mean square error of two sets of data; and the constitutive parameters of the piecewise linear/power-law hardening material model of the nanoindentation experimental material are calculated. The load-displacement curves in the experiment are corrected by using the indentation pile-up/sink-in parameter, and the above process is repeated until the calculation error of two calculations is within an allowable range. Then, a polycrystalline finite element model of a tensile specimen is established by using the crystal plasticity finite element method. By taking the crystal plasticity constitutive parameters as design variables, different crystal plasticity material parameters are extracted by using Latin hypercube sampling to calculate the stress-strain curve of the polycrystalline material, and the stress-strain curve is compared with the stress-strain curve of a piecewise linear/power-law strengthening model to calculate the mean square error of the two sets of data. The single-target optimization is conducted for relevant parameters of the Kriging surrogate model by using an optimization method based on the genetic algorithm with the target of the minimum mean square error of the two sets of data; and the crystal plasticity material parameters are calculated.

To achieve the above purpose, the present disclosure adopts the following technical solution:

A inversion identification method of crystal plasticity material parameters based on nanoindentation experiments comprises:

Step 1: nanoindentation experiment of a metal material to be tested;

1-1: cutting the metal material to be tested and obtaining a satisfactory nanoindentation specimen through mechanical polishing and vibration polishing;

1-2: conducting an indentation test on the indentation specimen in 1-1 by using a nanoindentation system to obtain experimental indentation responses comprising a load-displacement curve, a maximum load, contact stiffness and contact hardness; and obtaining the elastic modulus E of the material by using Oliver-Pharr method.

Step 2: establishing a conventional finite element model of nanoindentation based on a piecewise linear/power-law hardening material model in combination with MATLAB and ABAQUS, and inverting the macroscopic constitutive parameters (yield stress σ_{y} and strain hardening exponent n) of the material, wherein the constitutive description of the piecewise linear/power-law hardening material model is:

$$ɛ = \{ \begin{matrix}σ / E & if σ < {σ}_{y} \\ {σ}_{y}^{( n - 1 ) / n} {σ}^{1 / n} / E & otherwise\end{matrix}$$

wherein ε is total strain and σ is stress.

2-1: establishing a two-dimensional axisymmetric finite element model of nanoindentation by using ABAQUS; calculating the contact reaction force and displacement of an indenter along a penetration direction by using displacement-controlled loading, and outputting a contact force, the contact pressure and displacement of a contact surface of the specimen, and the displacement of a lowest node of the indenter to generate an input file;

2-2: extracting the constitutive parameters of the piecewise linear/power-law hardening material model in MATLAB by using Latin hypercube sampling; modifying the material parameters in the input file in 2-1; calculating an indentation load-displacement curve under each set of sampling parameters and the indentation pile-up/sink-in parameter s/h (s is pile-up or sink-in height; s is positive when pile-up occurs, and s is negative when sink-in occurs; h is penetration depth); calculating a mean square error between a simulated load-displacement curve and an experimental load-displacement curve; establishing a Kriging surrogate model of the constitutive parameters and the mean square error by using MATLAB; then conducting single-target optimization by using the genetic algorithm with the target of the minimum mean square error of two sets of data; calculating the constitutive parameters of the piecewise linear/power-law hardening material model of the experimental material; and recording the constitutive parameters and the elastic modulus of the material calculated by Oliver-Pharr method together as C0;

2-3: correcting the experimental load-displacement curve by using the pile-up/sink-in parameter in 2-2 to obtain a corrected load-displacement curve; then calculating a mean square error between the simulated load-displacement curve in 2-2 and the corrected load-displacement curve; repeating the simple-target optimization process in 2-2 (establishing the Kriging surrogate model of the constitutive parameters and the mean square error by using MATLAB, and then conducting simple-target optimization by using the genetic algorithm with the target of the minimum mean square error of the two sets of data); calculating the constitutive parameter of the piecewise linear/power-law hardening material model of the material after correction, and recording the constitutive parameter and the elastic modulus of the material calculated by the Oliver-Pharr method together as C1;

2-4: calculating the error between the material constitutive parameter calculated in 2-2 and the constitutive parameter corrected in 2-3; if the error is within the allowable range, using the constitutive parameter corrected in 2-3 as the macroscopic constitutive parameter of the material; if the error is beyond the allowable range, using the load-displacement curve corrected in 2-3 as the experimental load-displacement curve, and repeating the steps 2-2, 2-3 and 2-4 until the error is within the allowable range.

Step 3: establishing a polycrystalline finite element model of the tensile specimen by using the crystal plasticity finite element method in combination with MATLAB and ABAQUS, calculating the correspondence between the crystal plasticity material parameters and the piecewise linear/power-law hardening material parameters, and then inverting the crystal plasticity material parameters of the material to be tested.

3-1: establishing the crystal plasticity finite element model of the standard tensile specimen in ABAQUS, and providing the model with the crystal plasticity material parameters h₀, τₛ and τ₀ by using ABAQUS material subroutine; calculating the stress-strain curve of the material by using load-controlled loading; and generating an input file;

3-2: extracting the crystal plasticity material parameters in MATLAB by using Latin hypercube sampling; modifying the material parameters in the input file in 3-1; calculating the stress-strain curve under each set of sampling parameters; calculating the mean square error between the simulated stress-strain curve and the stress-strain curve under the macroscopic material parameters in 2-4; establishing the Kriging surrogate model of the crystal plasticity material parameters and the mean square error by using MATLAB; then conducting single-target optimization by using the genetic algorithm with the target of the minimum mean square error of two sets of data; and calculating the crystal plasticity material parameters of the experimental material.

Further, in the step 2-4, the error is the maximum value

$${( max \vert \frac{C 1 - C 0}{C 0} \vert )}_{i}$$

of the errors between the parameters.

Further, in the step 2-4, the allowable range of error is 0-2%.

Further, in the step 2, the elastic parameter and the plasticity parameter are separated in the process of material parameter inversion, the elastic parameter is solved by a mature theoretical method, and the plasticity parameter is solved by finite element inversion. In the process of solving the plasticity parameter using finite element inversion, the constitutive parameters of the piecewise linear/power-law hardening material model are extracted by using Latin hypercube sampling; the material parameters in the input file are modified; the indentation load-displacement curve under each set of sampling parameters and the indentation pile-up/sink-in parameter s/h are calculated; and the mean square error between the simulated load-displacement curve and the experimental load-displacement curve is calculated. In the inversion process of the crystal plasticity parameters in step 3, the crystal plasticity finite element model of the indentation is converted into the conventional finite element model of the indentation and the crystal plasticity finite element model of the tensile specimen.

Compared with the prior art, the present disclosure has the following technical effects:

(1) In the present disclosure, the elastic parameter and the plasticity parameter are obtained separately in the process of parameter inversion; after the influence of indentation pile-up/sink-in phenomenon on the penetration depth is considered and the load-displacement curve is corrected by using the finite element method, the elastic parameter is solved by the mature theoretical method, and the plasticity parameter is solved by finite element inversion, which improves the accuracy of the original data in the inversion process of the material parameters and reduces the amount of calculation.

(2) In the present disclosure, the crystal plasticity finite element model of the indentation in the inversion process of the crystal plasticity parameters is converted into the combined approach of using conventional finite element model of the indentation and the crystal plasticity finite element model of the tensile specimen. Since the indentation involves the nonlinear contact problem in the simulation process, the amount of calculation of the crystal plasticity finite element model of the indentation is greatly increased and the convergence is poor. While the combined approach of using conventional finite element model of the indentation and the crystal plasticity finite element model of the tensile specimen have small amount of calculation and good convergence. Therefore, the method of present disclosure has small amount of calculation, high calculation speed and good calculation convergence, and has high practical value and reference significance in the inversion identification of the crystal plasticity material parameters.

### DESCRIPTION OF DRAWINGS

FIG. 1 is a flow chart of present disclosure;

FIG. 2 is a experimental load-displacement curves;

FIG. 3 is a two-dimensional axisymmetric finite element model of nanoindentation;

FIG. 4 is a finite element model of a tensile specimen; and

FIG. 5 shows a stress-strain curve of nanoindentation inversion and a stress-strain curve of a tensile test.

### DETAILED DESCRIPTION

The present disclosure is further described below in combination with specific embodiments.

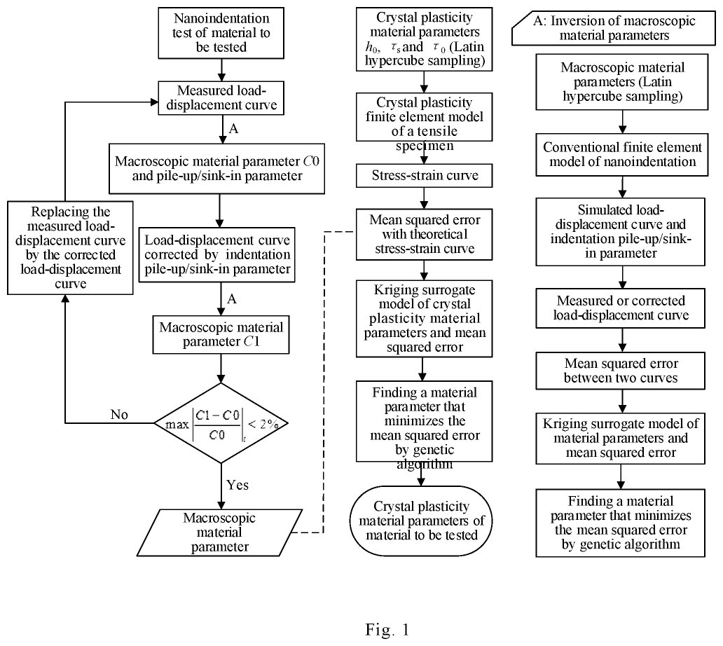

As shown in FIG. 1, a method for inversion calibration of microscopic constitutive parameters of metal materials based on nanoindentation and finite element modelling for crystal plasticity material parameters comprises concrete implementation steps:

Step 1: nanoindentation experiment of a metal material to be tested;

1-1: selecting 304 stainless steel material as a specimen, cutting the material and obtaining a satisfactory nanoindentation specimen through mechanical polishing and vibration polishing;

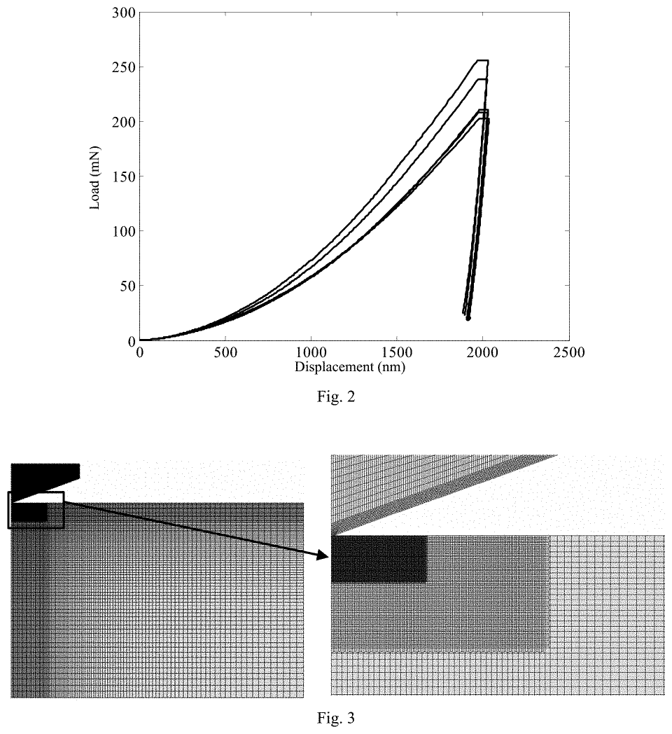

1-2: conducting an indentation test on the indentation specimen by using a Nano Indenter XP system; setting the penetration depth as 2 microns in the test, and obtaining experimental indentation responses comprising a load-displacement curve, a maximum load, contact stiffness and contact hardness; repeating the test for many times to obtain more than 5 effective test points, wherein the test load-displacement curve is shown in FIG. 2; meanwhile, calculating the elastic modulus E of the material as 196.08 GPa by using Oliver-Pharr method.

Step 2: establishing a conventional finite element model of nanoindentation based on a piecewise linear/power-law hardening material model in combination with MATLAB and ABAQUS, and inverting the constitutive parameters (yield stress σ_{y} and strain hardening exponent n) of the piecewise linear/power-law hardening material model;

2-1: By taking a conical indenter with a half cone angle of 70.3° equivalent to a Berkovich triangular pyramid indenter in step 1-2, establishing a two-dimensional axisymmetric finite element model of nanoindentation by using ABAQUS; locally refining a material grid under the indenter, with the model as shown in FIG. 3; calculating the contact reaction force and displacement of an indenter along a penetration direction by using displacement-controlled loading, and outputting a contact force, the contact pressure and displacement of a contact surface of the specimen, and the displacement of a lowest node of the indenter to generate an input file;

2-2: extracting 60 groups of elastic moduli E (selecting near the values calculated in 1-2), yield stress σ_{y} and strain hardening exponent n in MATLAB by using Latin hypercube sampling; calculating an indentation load-displacement curve under each set of sampling parameters and an indentation pile-up/sink-in parameter s/h; calculating a mean square error between a simulated load-displacement curve and an experimental load-displacement curve; establishing a Kriging surrogate model of the constitutive parameters and the mean square error by using MATLAB; then conducting single-target optimization by using the genetic algorithm with the target of the minimum mean square error of two sets of data; calculating the constitutive parameters (yield stress σ_{y} and strain hardening exponent n) of the piecewise linear/power-law hardening material model of the experimental material; and recording the constitutive parameters and the elastic moduli of the material calculated by Oliver-Pharr method together as C0;

2-3: adding the experimental displacement and the pile-up or sink-in height s to obtain a corrected contact depth and then obtain a corrected load-displacement curve; then calculating a mean square error between the simulated load-displacement curve in 2-2 and the corrected load-displacement curve; repeating the simple-target optimization process in 2-2; calculating the constitutive parameters (yield stress σ_{y} and strain hardening exponent n) of the piecewise linear/power-law hardening material model of the material after correction, and simultaneously using the elastic modulus of the material calculated by the Oliver-Pharr method and recording as C1;

2-4: calculating the error between the material parameter C0 calculated in 2-2 and C1 in 2-3; if the error is within 2%, using the constitutive parameter C1 calculated in 2-3 as the macroscopic constitutive parameter of the material; if the error is beyond 2%, using the load-displacement curve corrected in 2-3 as the experimental load-displacement curve, and repeating the steps 2-2, 2-3 and 2-4 until the error is less than 2%. At this moment, the elastic modulus E of 304 stainless steel is obtained as 196.12 GPa, the yield stress σ_{y} is 196 MPa, and the strain hardening exponent n is 0.251.

Step 3: establishing a polycrystalline finite element model of the tensile specimen by using the crystal plasticity finite element method in combination with MATLAB and ABAQUS, calculating the correspondence between the crystal plasticity material parameters (initial yield stress τ₀, initial hardening modulus h₀ and stage I stress τₛ) and the piecewise linear/power-law hardening material parameters (yield stress σ_{y} and strain hardening exponent n), and then inverting the crystal plasticity material parameters of the material to be tested;

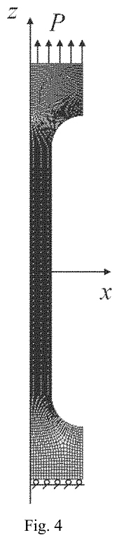

3-1: establishing the finite element model of the standard tensile specimen in ABAQUS as shown in FIG. 4, providing the model with the crystal plasticity material parameters by using ABAQUS material subroutine and then establishing the crystal plasticity finite element model of the standard tensile specimen; calculating the stress-strain curve of the material by using load-controlled loading; and generating an input file;

3-2: extracting 60 sampling points of initial hardening moduli and saturated yield stress in MATLAB by using Latin hypercube sampling; modifying the material parameters in the input file in 3-1; calculating the stress-strain curve under each set of sampling parameters; calculating the mean square error between the stress-strain curve and the stress-strain curve under the macroscopic material parameters in 2-4; establishing the Kriging surrogate model of the crystal plasticity material parameters and the mean square error by using MATLAB; then conducting single-target optimization by using the genetic algorithm with the target of the minimum mean square error of two sets of data; and calculating the initial yield stress τ₀ of the material to be tested as 86.11 MPa, the initial hardening modulus h₀ as 220.52 MPa and the stage I stress τₛ as 256.35 MPa.

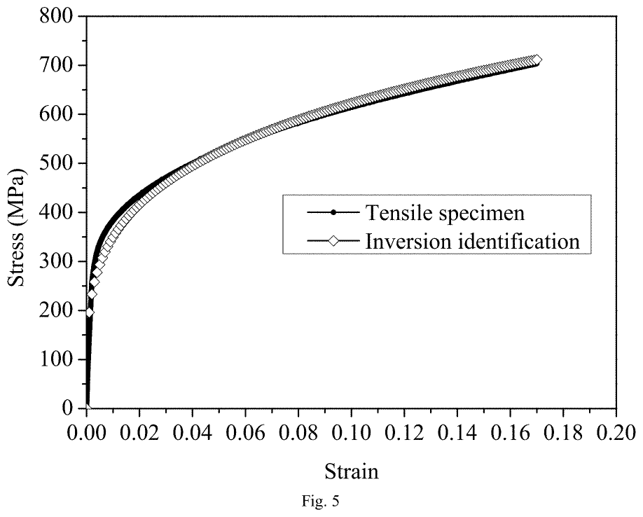

Step 4: in order to verify the material parameters obtained by inversion, conducting a tensile test on the same 304 stainless steel material, wherein the comparison between the obtained stress-strain curve and the stress-strain curve obtained in step 2 is shown in FIG. 5. The initial yield stress τ₀ calculated from the curve is 85.09 MPa, the initial hardening modulus h₀ is 218.77 MPa, and the stage I stress rₛ is 260.52 MPa. It can be seen from the comparison results that the stress-strain curves and the crystal plasticity parameters calculated by the two methods have little difference. The inversion identification method is reasonable, effective and highly accurate, and the entire inversion identification process is correct.

The above embodiments only express the implementation of the present disclosure, and shall not be interpreted as a limitation to the scope of the patent for the present disclosure. It should be noted that, for those skilled in the art, several variations and improvements can also be made without departing from the concept of the present disclosure, all of which belong to the protection scope of the present disclosure.

1. An inversion identification method of crystal plasticity material parameters based on nanoindentation experiments, comprising: firstly, obtaining the elastic modulus of material by using Oliver-Pharr method to simplify a macroscopic constitutive parameter inversion model; secondly, establishing a macroscopic parameter inversion model of nanoindentation by using a piecewise linear/power-law hardening material model in combination with MATLAB and ABAQUS, correcting actual nanoindentation experimental data by using pile-up/sink-in parameters and calculating macroscopic constitutive parameters of material to be tested in combination with a Kriging surrogate model and a genetic algorithm; and finally, establishing a polycrystalline finite element model of a tensile specimen by using the crystal plasticity finite element method, and calculating the crystal plasticity material parameters of experimental material in combination with the Kriging surrogate model and the genetic algorithm.

2. The inversion identification method of crystal plasticity material parameters based on nanoindentation experiments according to claim 1, specifically comprising steps of:
step 1: nanoindentation experiment of a metal material to be tested;
1-1: cutting the metal material to be tested and obtaining a satisfactory nanoindentation specimen through mechanical polishing and vibration polishing;
1-2: conducting an indentation test on the indentation specimen in step 1-1 by using a nanoindentation system to obtain experimental indentation responses comprising a load-displacement curve, a maximum load, contact stiffness and contact hardness; and obtaining the elastic modulus E of the material by using the Oliver-Pharr method;
step 2: establishing a conventional finite element model of nanoindentation based on the piecewise linear/power-law hardening material model in combination with MATLAB and ABAQUS, and inverting the macroscopic constitutive parameters of the material: yield stress σ_{y} and strain hardening exponent n, wherein the constitutive description of the piecewise linear/power-law hardening material model is:
$$ɛ = \{ \begin{matrix}σ / E & if σ < {σ}_{y} \\ {σ}_{y}^{( n - 1 ) / n} {σ}^{1 / n} / E & otherwise\end{matrix}$$
wherein ε is total strain and σ is stress;
2-1: establishing a two-dimensional axisymmetric finite element model of nanoindentation by using ABAQUS; calculating the contact reaction force and displacement of an indenter along a penetration direction by using displacement-controlled loading, and outputting a contact force, the contact pressure and displacement of a contact surface of the specimen, and the displacement of a lowest node of the indenter to generate an input file;
2-2: extracting the constitutive parameters of the piecewise linear/power-law hardening material model in MATLAB by using Latin hypercube sampling; modifying the material parameters in the input file in step 2-1; calculating an indentation load-displacement curve under each set of sampling parameters and an indentation pile-up/sink-in parameter s/h, wherein s is pile-up or sink-in height; s is positive when pile-up occurs, and s is negative when sink-in occurs; and
h is penetration depth; calculating a mean square error between the simulated load-displacement curve and the experimental load-displacement curve; establishing the Kriging surrogate model of the constitutive parameters and the mean square error; then conducting single-target optimization by using the genetic algorithm with the target of the minimum mean square error of two sets of data; and calculating the constitutive parameters of the piecewise linear/power-law hardening material model of the experimental material;
2-3: correcting the experimental load-displacement curve by using the indentation pile-up/sink-in parameter in step 2-2 to obtain a corrected load-displacement curve; then calculating the mean square error between the simulated load-displacement curve in step 2-2 and the corrected load-displacement curve; repeating the simple-target optimization process in step 2-2; and calculating the constitutive parameters of the piecewise linear/power-law hardening material model of the material after correction;
2-4: calculating the error between the constitutive parameters of the piecewise linear/power-law hardening material model calculated in step 2-2 and the constitutive parameters corrected in step 2-3; if the error is within an allowable range, using the constitutive parameters corrected in step 2-3 as the macroscopic constitutive parameters of the material; if the error is beyond the allowable range, using the load-displacement curve corrected in step 2-3 as the experimental load-displacement curve, and repeating the steps 2-2, 2-3 and 2-4 until the error is within the allowable range;
step 3: establishing the polycrystalline finite element model of a tensile specimen by using the crystal plasticity finite element method in combination with MATLAB and ABAQUS, calculating the correspondence between the crystal plasticity material parameters and the piecewise linear/power-law hardening material parameters, and then inverting the crystal plasticity material parameters of the material to be tested;
3-1: establishing a crystal plasticity finite element model of a standard tensile specimen in ABAQUS; calculating the stress-strain curve of the material by using the load-controlled loading; and generating an input file;
3-2: extracting the crystal plasticity material parameters in MATLAB by using Latin hypercube sampling; modifying the material parameters in the input file in step 3-1; calculating the stress-strain curve under each set of sampling parameters; calculating the mean square error between the simulated stress-strain curve and the stress-strain curve under the macroscopic material parameters in step 2-4; establishing the Kriging surrogate model of the crystal plasticity material parameters and the mean square error by using MATLAB; then conducting single-target optimization by using the genetic algorithm with the target of the minimum mean square error of two sets of data; and calculating the crystal plasticity material parameters of the material.

3. The inversion identification method of crystal plasticity material parameters based on nanoindentation experiments according to claim 2, wherein in the step 2, an elastic parameter and a plasticity parameter are separated in the process of material parameter inversion, the elastic parameter is solved by a mature theoretical method, and the plasticity parameter is solved by finite element inversion.

4. The inversion identification method of crystal plasticity material parameters based on nanoindentation experiments according to claim 2, wherein in the step 2-4, the allowable range of error is 0-2%.
